(19) United States
(12) Patent Application Publication
(10) Pub. No.: US 2013/0038770 A1
(43) Pub. Date: Feb. 14, 2013

(54) Sports Video Training Accessory

(71) Applicant: James Hawkins, Lake Bluff, IL (US)

(72) Inventor: James Hawkins, Lake Bluff, IL (US)

(21) Appl. No.: 13/572,168

(22) Filed: Aug. 10, 2012

Related U.S. Application Data
(60) Provisional application No. 61/522,106, filed on Aug. 10, 2011.

(51) Int. Cl. F16M 11/12; F16M 11/38; F16M 11/18; H04N 5/225; F16M 13/00

(52) U.S. Cl. 348/333.01; 248/176.3; 248/156; 248/157; 348/E05.024

(57) ABSTRACT

A system for providing feedback to an individual involved in improving an activity such as a sport, performance or the like. The present invention relates to a training accessory, and more particularly to a holding apparatus for mounting a video or photographic device, such as a digital camera having a display device for feedback, such as a tablet PC, i-phone, i-pad, cell phone having a screen, multimedia device, or the like. The imaging and display device being easily transportable and easy to set up, for example, on a golf course where multiple instances are required, yet does not interfere with the playing of the game.

### CROSS REFERENCE TO RELATED APPLICATIONS

This application claims priority from U.S. provisional application 61/522,106 filed 10 Aug. 2011; entitled “Sports Video Training Accessory”. The entire contents being hereby incorporated by reference and for which benefit of the priority date is claimed.

### FIELD OF THE INVENTION

The present invention relates to a training accessory, and more particularly to a holding apparatus for mounting a video or photographic device, such as a digital camera having a display device for feedback, such as a tablet PC, i-phone, i-pad, cell phone having a screen, multimedia device, or the like. The imaging and display device being easily transportable and easy to set up, for example, on a golf course where multiple instances are required, yet does not interfere with the playing of the game.

### BACKGROUND OF THE INVENTION

Highly competitive performers such as athletes are constantly looking for a differentiating factor or edge in their performance. Small variations in stance, swing, arc, and the like can make a tremendous difference in performance for a baseball player, golfer, basketball player, or many other competitive games or sports.

For example, golfers can pay thousands of dollars for golf lessons comprising constant feedback from a professional to correct grip, stance, or mechanical movement, only find that once on the golf course, and without the feedback, hard won advances are lost. Many have resorted to videotaping their performance in order to study their golf swing, only to find that the equipment is expensive and requires significant set up and takedown, which can greatly interfere with the fun of the game.

In a separate application of the present invention, those involved in the performance arts also require feedback on performances, acting, singing and the like. The present accessory is anticipated to be used in applications such as this.

With the advent of devices such as tablet PC's having cameras and inexpensive apps interactive training is possible for the individual wishing to understand his or her golf swing and get instant feedback. Until now there was no way to have a transportable easy to set-up stand that could be taken to the practice area, course, or stage.

### SUMMARY OF THE INVENTION

The object of this invention is to provide a mobile durable lightweight adjustable stand that can accept in a snap on fashion the new tablet computers or cell phones with golf apps becoming popularized today. The stand is versatile enough to be used as an inexpensive, easily transportable tripod for filming or photography with these new devices

### BRIEF DESCRIPTION OF THE DRAWINGS

An understanding of the present invention may be obtained by reference to the accompanying drawings, when considered in conjunction with the subsequent, detailed description, in which:

FIG. 1 is a perspective view of one typical set-up embodiment;

FIG. 2 is a rear perspective view of an accessory holding a feedback device;

FIG. 3 is a perspective view an accessory being stored for transport and later use.

FIGS. 4A, B show a sectional view of detail of the mechanism for a ground stake with stabilizing legs.

FIGS. 5A, B show a schematic representation of an accessory having rotation of the imaging device.

FIG. 6 shows a schematic representation of a tilt mechanism.

### DETAILED DESCRIPTION

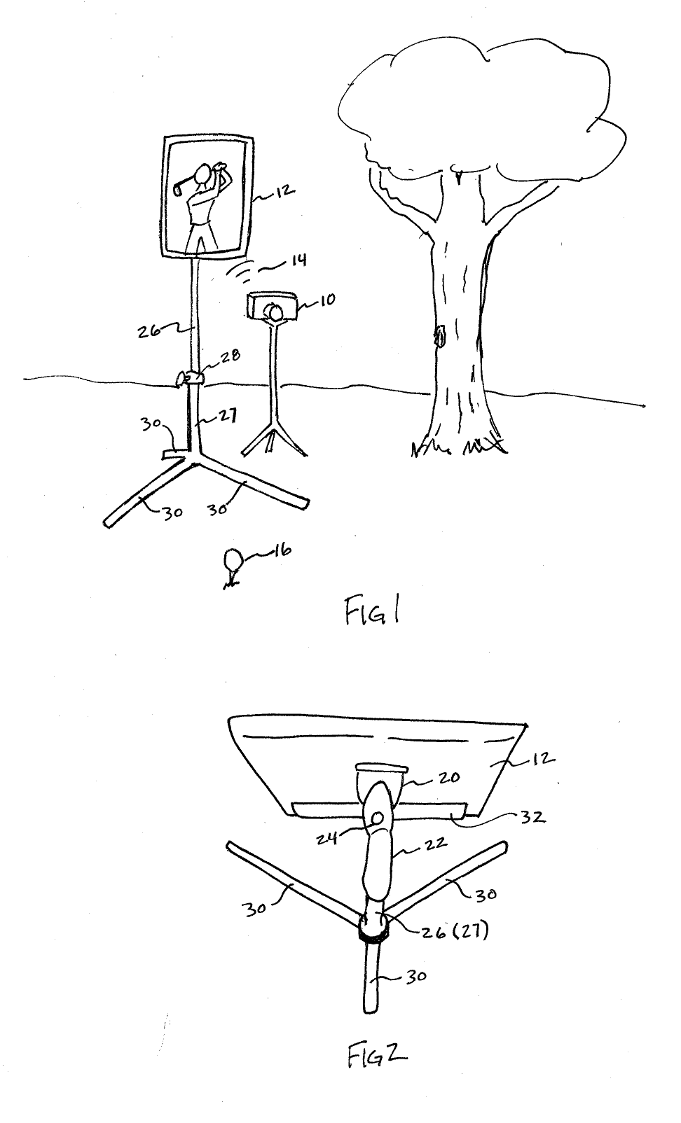

Elements; (2) feedback device—which can comprise any combination of elements (10), (12) and (18); (10) imaging device, (12) display device, (14) signal, (16) ball, (18) processor (not shown), (20) attachment means, (22) handle, (24) positioning means, (26) body, (28) adjustment, (30) legs, (32) support. In the instance of FIG. 1 the imaging device (10). The user can use the feedback imaging device in real time to gain feedback regarding the set-up and stance. Additionally, the user can collect immediate feedback after the fact, by playing back the recorded images on the imaging device.

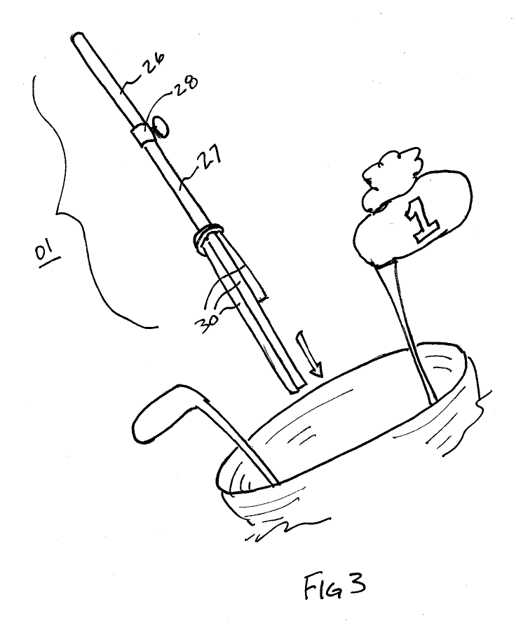

In this first embodiment shown in FIGS. 1-3, the accessory further comprises an attachment device (20) which is typically a snap type quick connect, a handle (22) for ease in positioning, a swivel (24), a support for stabilization of the feedback device (2), which are supported by a body (26) which is inter-digitated with a lower body (27) by means of an adjustment mechanism (28) which in this case is a locking bolt.

Upon completion of the feedback process, the feedback device (02) can be removed, and the entire accessory (01) can be quickly folded for quick and easy transport. In this case, in a golf bag.

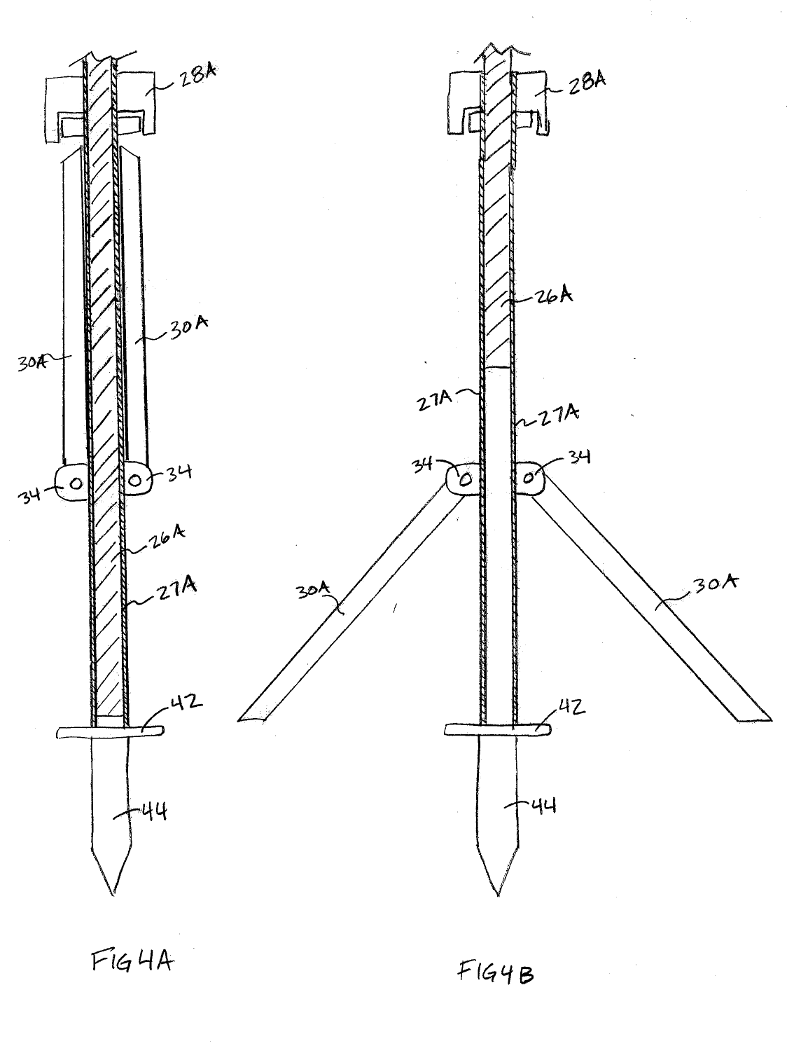

FIGS. 4A and B, show an alternate embodiment of the body mechanism having a compression bushing for the adjustment mechanism (28A), the bushing can be knurled for ease of use. Further, the legs (30A), preferably three which can be glass filled, can be snapped into place next to the lower body (27A). Preferably, the lower body (27A) is tube-like or hollow, and the upper body (26A) is inserted and can be used for extension purposes. A ledge (42) is provided and sized to be used for foot pressure to drive a stake (44) or spike into the ground to provide improved stability. The legs (30A) should preferably be sized such that in an extended position, the bottoms of the legs (30A) are at substantially the same level as the ledge (42).

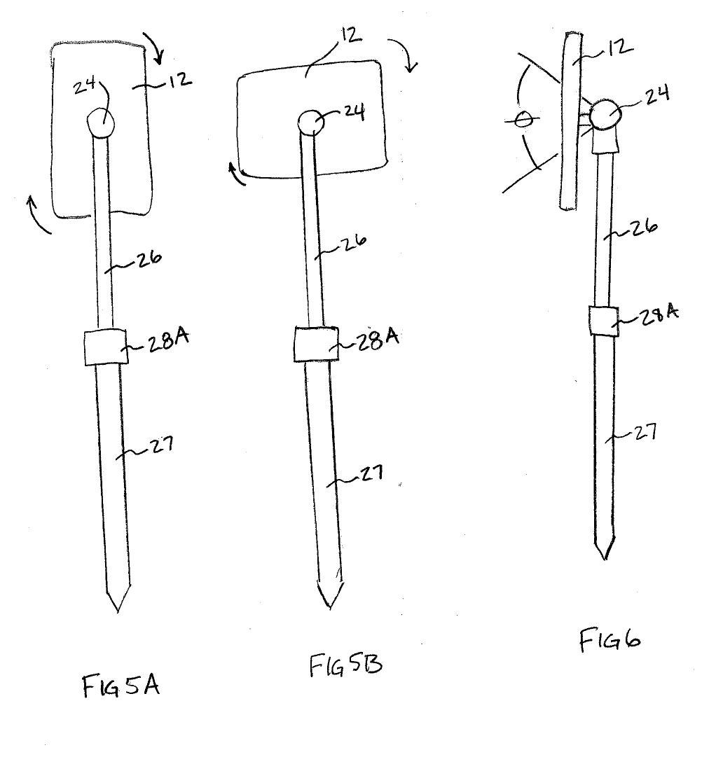

As to functionality of the accessory (01), the swivel (24) should operate as a ball in socket type operation providing full rotation of the display device (12) shown in FIG. 5. The accessory (01) is preferred to have some horizontal movement as shown by theta in FIG. 6. In this case theta can have a value of 30 degrees, and preferably more.

### Conclusion, Ramifications, and Scope

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

Having thus described the invention, what is desired to be protected by Letters Patent is presented in the subsequent appended claims.

We claim:

1. A system for providing visual feedback by means of a tablet device, ipod, smart phone, or the like, comprising:
(i) a structure comprising lineal elements and a holder being suited to support a digital feedback (tablet) device in a position to provide feedback to a user;
(ii) the digital feedback device having a quick attachment means for attaching to the holder;
(iii) the structure and the holder capable of being manipulated in such a way as to allow videotaping at a proper height and direction to provide meaningful feedback to an athlete.

2. A stand or structure to elevate and support a holder consisting of structural elements
(i) A tablet device holder than can be simply attached to the stand so it faces outward to the stand and allows for filming from either side of the device
(ii) A means of attaching the holder to the stand
(iii) And a means to simply attach a tablet computer to the holder
(iv) The holder being capable of being situated in such a way as to allow videotaping at the proper height for swing analysis.

3. The stand or structure of claim 2, wherein the stand is lightweight weighing less than 3 pounds.

4. The stand or structure of claim 2, wherein the stand has a diameter of its width section in the folded position of no more than approximately 4 inches to be able to be inserted into a golf bag club portion.

5. The stand or structure of claim 2, wherein the stand is a folding stand.

6. The stand or structure of claim 2, wherein the holder has a depth of no more than 4 inches for carrying in a golf bag pouch

7. The stand or structure of claim 2, wherein the stand is a folding stand of 2 or more supporting base sections working on concert together.

8. The stand or structure of claim 2, wherein the stand is a stand with an integral spike to inset the stand into the ground without the use of supporting base sections.

9. The stand or structure of claim 2, wherein the stand is a stand having the flexibility of the extension of the height.

10. The stand or structure of claim 2, wherein the stand is a stand allowing for repositioning of the tablet holder to the preferred height for various types of video or picture taking via a tablet.

11. The stand or structure of claim 2, wherein the tablet holder has the capability of being rotated and tilted along its lengthwise and widthwise axis for proper aim.

12. The stand or structure of claim 2, wherein the tablet holder is capable of being rotated 360 degrees to a any position including vertical or horizontal orientation tablet orientations along its depth-wise axis.

13. The stand or structure of claim 2, wherein the holder allows for filming from one side of the device.

14. A method for providing a mobile feedback and training routine for an athlete comprising the following:
(i) providing a feedback device for giving visual feedback to at least one athlete;
(ii) mounting the feedback device to a device holder, the device holder comprising; lineal elements for providing structure, a simple attach and release mechanism for interfacing the feedback device to the device holder, an imaging device for taking at least one of a still and video images, a display device for providing images;
(iii) manipulating the device holder such that the feedback device is at a proper height and position for meaningful visual feedback to the athlete;
(iv) using the feedback device to provide feedback to at least one athlete;
(v) releasing the feedback device from the device holder;
(vi) moving the feedback device and device holder to a different location and repeating the process.

15. The method for providing a mobile feedback and training routine for an athlete according to claim 14 further comprising aiming the feedback device at the athlete.

16. The method for providing a mobile feedback and training routine for an athlete according to claim 14 wherein the feedback device is mobile.

17. The method The method for providing a mobile feedback and training routine for an athlete according to claim 14 wherein the feedback device and device holder can be easily carried in a golf bag.
